(19) United States
(12) Patent Application Publication
(10) Pub. No.: US 2012/0196063 A1
(43) Pub. Date: Aug. 2, 2012

(54) MULTI-LAYER METALIZED THERMAL BAG

(75) Inventor: Alice K. Duong, San Diego, CA (US)

(73) Assignee: Coldpack, Inc., San Diego, CA (US)

(21) Appl. No.: 13/091,115

(22) Filed: Apr. 20, 2011

Related U.S. Application Data
(60) Provisional application No. 61/326,599, filed on Apr. 21, 2010.

(51) Int. Cl. B32B 15/00

(52) U.S. Cl. 428/35.3

(57) ABSTRACT

A thermal material includes a first layer comprising a first side and a second metalized side opposing the first side and a second layer comprising a first side and a second metalized side opposing the first side. The second layer is laminated to the first layer to form a plurality of laminated layers. The thermal material also includes a seal formed at a peripheral edge of the plurality of laminated layers.

### CROSS REFERENCES TO RELATED APPLICATIONS

The present application claims priority to U.S. Provisional Patent Application No. 61/326,599, filed on Apr. 21, 2010, the disclosure of which is hereby incorporated by reference in its entirety for all purposes.

### BACKGROUND OF THE INVENTION

Packaging of materials is utilized in a variety of industries. Despite the progress made in packaging technology, there is a need in the art for improved methods and systems related to packaging of products.

### SUMMARY OF THE INVENTION

Embodiments of the present invention relate to packaging technology. More particularly, embodiments of the present invention provide a thermal bag including a plurality of layers, each of the layers including a metalized film. The invention is not limited to this particular structure but can include other packaging designs as well.

According to an embodiment of the present invention, a thermal material is provided. The thermal material includes a first layer comprising a first side and a second metalized side opposing the first side and a second layer comprising a first side and a second metalized side opposing the first side. The second layer is laminated to the first layer to form a plurality of laminated layers. The thermal materials also includes a seal formed at a peripheral edge of the plurality of laminated layers.

According to another embodiment of the present invention, a thermal material is provided. The thermal materials includes a first sheet of plastic having a metalized side and a non-metalized side, a first edge area and a second edge area. The thermal material also includes a second sheet of plastic having a metalized side and a non-metalized side, a first edge area and a second edge area. The second sheet is disposed adjacent to the first sheet such that the non-metalized side of the first sheet is adjacent to the metalized side of the second sheet and the first edge area of the first sheet is fastened to the first edge area of the second sheet and the second edge area of the first sheet is fastened to the second edge area of the second sheet.

According to yet an embodiment of the present invention, a thermal material is provided. The thermal material includes a first layer comprising a first side and a second polyethelene foam side opposing the first side and a second layer comprising a first side and a second polyethelene foam side opposing the first side. The second layer is laminated to the first layer to form a plurality of laminated layers. The thermal material further includes a seal formed at a peripheral edge of the plurality of laminated layers.

### BRIEF DESCRIPTION OF THE DRAWINGS

FIG. 1 illustrates manufacturing details for a thermal bag provided according to an embodiment of the present invention;

FIG. 2 illustrates a bag formed according to embodiments of the present invention in a flat configuration;

FIG. 3 illustrates a bag formed according to embodiments of the present invention inserted into a larger packaging container; and

FIG. 4 illustrates a metalized thermal bag closed inside of a container.

### DETAILED DESCRIPTION OF THE INVENTION

Embodiments of the present invention provide a bag comprised of multiple layers of one-sided metalized film that are sealed together to form one unit. The bag provides thermal insulation protection for perishable products and/or temperature sensitive products.

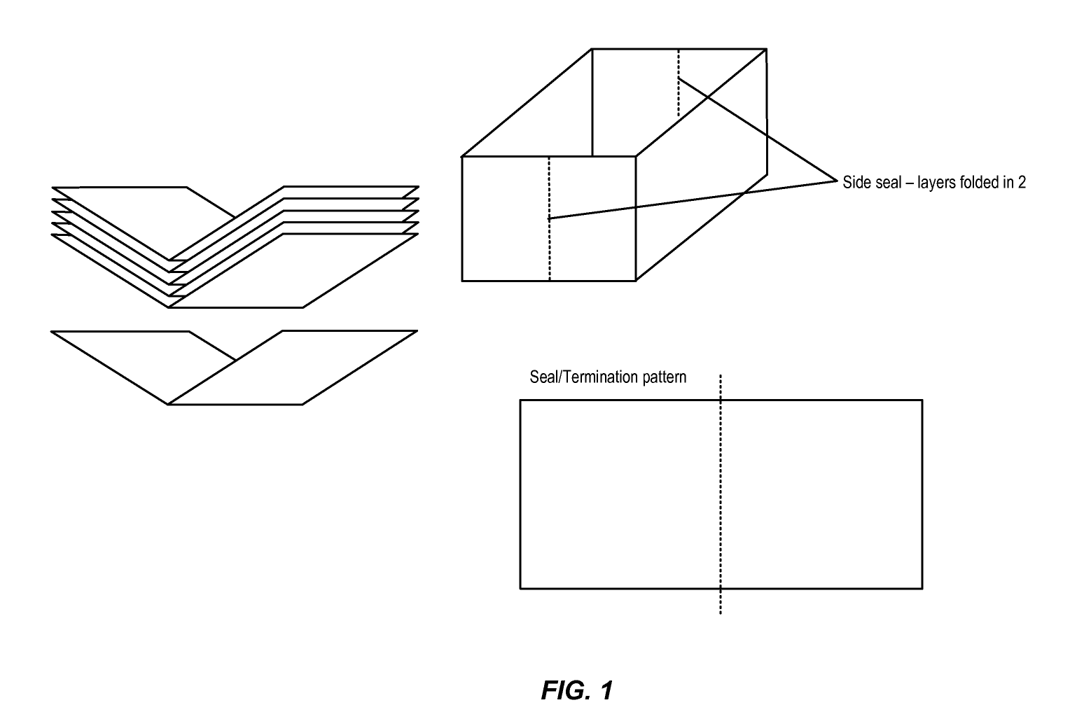

Exemplary manufacturing details are illustrated in FIG. 1. Referring to FIG. 1, a thermal liner is formed by arranging multiple layers in a structure. In the illustrated embodiment, multiple layers of a metalized film are positioned adjacent each other and laminated to form a single structure. The multiple layers are laminated with two or more layers in contact with each other, for example, all the layers oriented in the same orientation, for example, facing outwards. Embodiments of the present invention are not limited to this particular design and one or more layers could be facing in an opposite orientation.

According to one embodiment of the present invention, the one-sided metalized film can be fabricated using one of several metals, including aluminum, gold, copper, or other suitable metals and metal alloys. The metalized film can be formed as a continuous surface or in a patterned format in order to create different performance parameters.

The films can be coextruded and can be made out HDPE, LDPE, Nylon, Surlyn, or other plastics. Each film is the metalized on one side via evaporation, sputtering, lamination, or the like.

Conversion of rolls stock of metalized film can be done by heat seal or lamination methods.

Referring once again to FIG. 1, two of the laminated structures can be joined or sealed on opposing edges to form a box-shaped structure with an open top and bottom. In other embodiments, more than two laminated structures are joined to form the box-shaped structure. In yet another embodiment, a single laminated structure is folded and sealed to form the box-shaped structure. Thus, the perimeter can be sealed or the sides can be sealed along with folding to form a bag. In some embodiments, the sides of the structure are sealed after folding to form a bag.

According to embodiments of the present invention, a number of layers of the metalized film are laminated to form a resulting structure, which can be formed into the shape of a bag. As an example, two or more layers, for example, 3, 4, 5, 6, 7, 8, 9, 10, or more layers can be used to provide the desired thermal insulation. Once formed, the bag can be inserted into a container or box to provide thermal insulation for goods located inside the bag. The bag could be inserted in another insulating box, container, bag, or the like, to provide supplementary insulation.

All layers are sealed, laminated on the sides to become a single unit bag with a wide opening on top to allow user to insert products. The metalized side is facing outward in some embodiments. According to embodiments, the one-sided metalized films are oriented in the same direction, with adjacent metal layers separated by the substrate on which the metalized layer is formed.

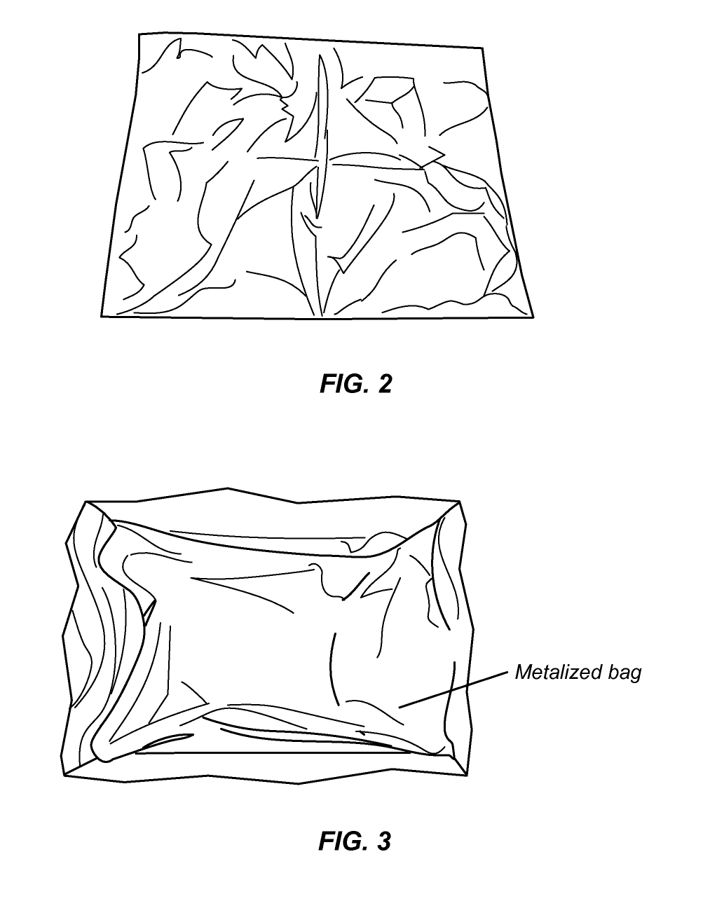

FIG. 2 illustrates a bag formed according to embodiments of the present invention in a flat configuration. In the embodiment illustrated in FIG. 2, the laminated structure is not folded as illustrated in FIG. 1, but is provided in a flat configuration. Such a flat thermal liner could be used to wrap temperature sensitive items or the like.

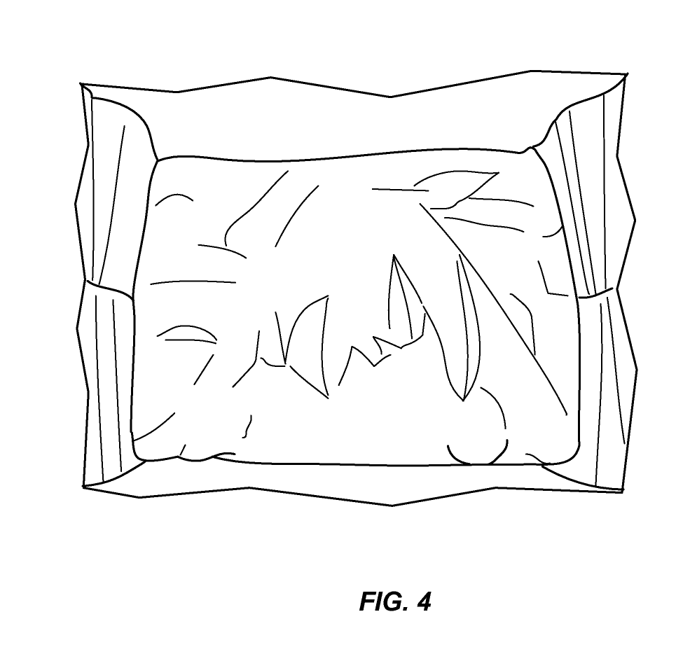

FIG. 3 illustrates a bag formed according to embodiments of the present invention inserted into a larger packaging container. In the embodiment illustrated in FIG. 3, the flat bag illustrated in FIG. 2 is inserted into a box to form an interior portion of a thermally insulating box that can be used to thermally insulate the materials inside the box from the surrounding atmosphere.

FIG. 4 illustrates a metalized thermal bag closed inside of a container.

In some embodiments, the metalized film discussed above is replaced with a polyethelene foam provided on one side of a film, for example, a plastic film and then multiple layers of the film/polyethelene film are laminated to form the insulating structures described herein. Thus, the description related to film/metal layers is applicable to the embodiments including a polyethelene foam in place of the metalized film. In other embodiments, a combination of a metalized film and a polyethelene foam is used to form each of the layers. In an alternative embodiment, a structure including one or more layers of film/metalized film and one or more layers of film/polyethelene film is provided. One of ordinary skill in the art will appreciate many alternatives and variations.

Benefits provided by embodiments of the present invention include enhanced thermal performance in comparison with other packaging techniques. Embodiments of the present invention provide flexible, thermally insulating containers not available using conventional techniques.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A thermal material comprising:
a first layer comprising a first side and a second metalized side opposing the first side;
a second layer comprising a first side and a second metalized side opposing the first side, wherein the second layer is laminated to the first layer to form a plurality of laminated layers; and
a seal formed at a peripheral edge of the plurality of laminated layers.

2. The thermal material of claim 1 wherein each of the laminated layers comprise a one-sided metalized film.

3. The thermal material of claim 2 wherein the one-side metalized film comprises at least one of aluminum, gold, or copper.

4. The thermal material of claim 1 wherein each of the laminated layers are positioned in a same orientation.

5. The thermal material of claim 1 further comprising additional layers, wherein the plurality of laminated layers comprise three or more layers.

6. A thermal bag comprising:
the thermal material of claim 1, wherein the thermal material of claim 1 is folded to overlap a portion of the thermal material and another portion of the thermal material; and
two edges laminated to form the thermal bag.

7. A thermal material comprising:
a first sheet of plastic having a metalized side and a non-metalized side, a first edge area and a second edge area; and
a second sheet of plastic having a metalized side and a non-metalized side, a first edge area and a second edge area, said second sheet disposed adjacent to the first sheet such that the non-metalized side of the first sheet is adjacent to the metalized side of the second sheet and the first edge area of the first sheet is fastened to the first edge area of the second sheet and the second edge area of the first sheet is fastened to the second edge area of the second sheet.

8. The thermal material of claim 7 each of the laminated layers comprise a one-sided metalized film.

9. The thermal material of claim 8 wherein the metalized side of the first sheet and the metalized side of the second sheet comprises at least one of aluminum, gold, or copper.

10. The thermal material of claim 7 further comprising additional sheets of plastic, each having a metalized side and a non-metalized side.

11. A thermal material comprising:
a first layer comprising a first side and a second polyethelene foam side opposing the first side;
a second layer comprising a first side and a second polyethelene foam side opposing the first side, wherein the second layer is laminated to the first layer to form a plurality of laminated layers; and
a seal formed at a peripheral edge of the plurality of laminated layers.

12. The thermal material of claim 11 wherein the first layer further comprises a metalized film and the second layer further comprises the metalized film.

13. The thermal material of claim 12 wherein the one-side metalized film comprises at least one of aluminum, gold, or copper.

14. The thermal material of claim 11 wherein each of the laminated layers are positioned in a same orientation.

15. The thermal material of claim 11 further comprising additional layers, wherein the plurality of laminated layers comprise three or more layers.
